(19) United States
(12) Patent Application Publication
(10) Pub. No.: US 2009/0285510 A1
(43) Pub. Date: Nov. 19, 2009

(54) Structure of a packing container

(76) Inventor: Ching-Sen Huang, Lucao Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,026

(22) Filed: May 13, 2008

(51) Int. Cl. B65D 33/16; B65D 30/00; B67D 5/42; B65D 47/34

(52) U.S. Cl. 383/80; 222/383.1

(57) ABSTRACT

A packing container is used to contain liquid such as drinks, detergents, and cosmetics, and includes a packing bag, and a closing component; the closing component has an opening end, and a joining end, which is substantially rhombic, and has a mesh-like joining piece extending in a substantially upright position from each of front and rear sides thereof; the joining end further has a plate-shaped piece extending sideways from each of left and right vertex angles thereof; in assembly, the joining end of the closing component is held within an opening of the packing bag, and hot-press joining process is carried out to make the joining end firmly and watertightly joined on an inner side of the packing bag; owing to the mesh-like pieces and the plate-shaped pieces, closing components can be firmly joined on packing bags easily with relatively little risk of poor connection forming between both.

### BACKGROUND OF THE INVENTION

1. Field of the Invention

The present invention relates to a packing container structure, more particularly one, which includes a packing bag, and a closing component with a mesh-like joining end capable of being firmly joined on an inner side of the packing bag with relatively little risk of apertures forming between both.

2. Brief Description of the Prior Art

In the light of the harm caused to the environment by the ever increasing discarded plastic bottles of liquid products such as detergents, shampoos, bath creams, and liquid cosmetics, many people have changed from the traditional environmentally-unfriendly way of disposing used bottles to an environmentally-friendly and resource-saving way, which is to refill the bottles with liquid products packed in refill bags after the contents of the bottles run out.

Referring to FIG. 5, a currently existing detergent/liquid refill bag includes a packing bag, and a closing component 3 joined on an upper end of the packing bag. The closing component 3 has an opening end 31, and a joining end 32; the opening end 31 has threads 311 on an outer circumferential side for a cap 312 to be threadedly joined thereon; the joining end 32 is substantially in the shape of rhombus, and has several joining plate parts 321 horizontally extending from each of front and rear sides thereof. In assembly, a hot-press joining process is carried out to firmly join the joining plate parts 321 of the closing component 3 on the packing bag.

The above refill bag is found to have the following drawbacks:

1. The area of contact between each of the joining plate parts and the packing bag is relatively small, and in turn there will be relatively much risk of poor connection forming between the closing component and the packing bag. Consequently, there will be relatively high rate of defective products in mass production.

2. Apertures will form between the joint between the closing component and the packing bag, and liquid contents of the packing bag will leak out if poor connection has been formed without being detected in manufacturing.

### SUMMARY OF THE INVENTION

For the above reason, it is a main object of the present invention to provide an improvement on a packing container structure, which allows a closing component and a packing bag to be firmly and watertightly joined together by a hot-press joining process with relatively little risk of poor connection.

A packing container structure according to an embodiment of the preset invention includes a packing bag, and a closing component. The closing component has an opening end, and a joining end, which is substantially rhombic, and has a mesh-like joining piece extending in a substantially upright position from each of front and rear sides thereof. The joining end further has a plate-shaped piece extending sideways from each of left and right vertex angles thereof. In assembly, the joining end of the closing component is held within an opening of the packing bag, and hot-press joining process is carried out to make the joining end firmly and watertightly joined on an inner side of the packing bag. Owing to the mesh-like pieces and the plate-shaped pieces, the closing component can be firmly joined on the packing bag relatively easily with the hot-press joining process.

### BRIEF DESCRIPTION OF THE DRAWINGS

The present invention will be better understood by referring to the accompanying drawings, wherein:

FIG. 1 is a perspective view of a first preferred embodiment of the present invention,

FIG. 2 is a perspective view of a closing component of the first preferred embodiment,

FIG. 3 is a side view of the first preferred embodiment,

FIG. 4 is a perspective view of a closing component of a second preferred embodiment of the present invention, and

FIG. 5 is a perspective view of the prior closing component.

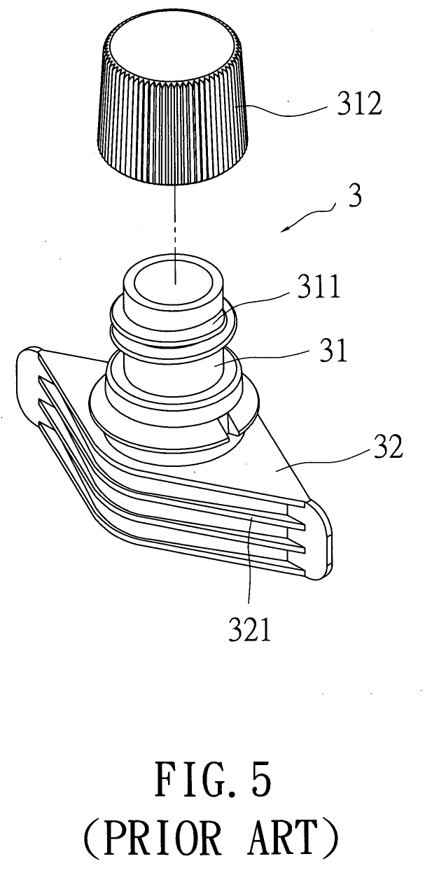

### DETAILED DESCRIPTION OF THE PREFERRED EMBODIMENTS

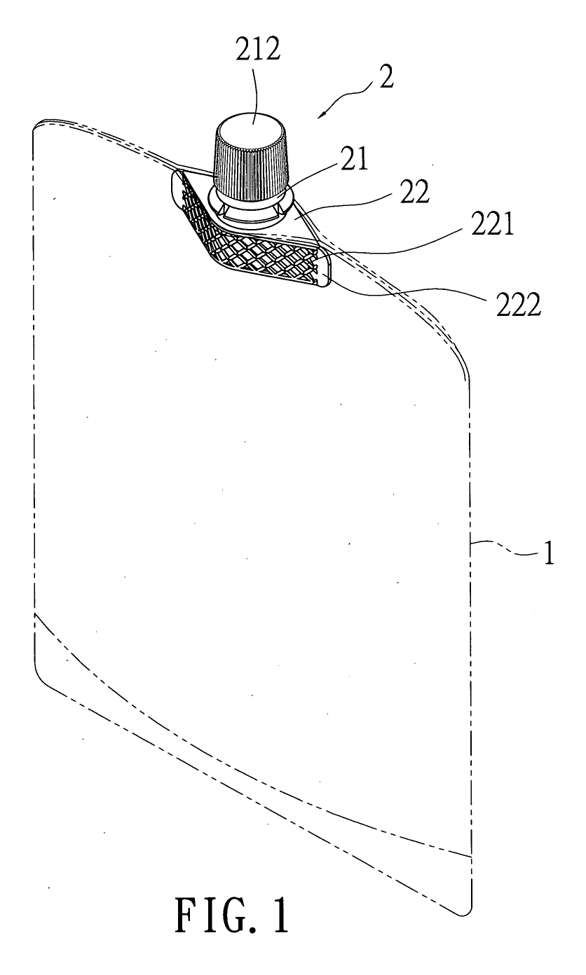

Referring to FIG. 1, a first preferred embodiment of a packing container of the present invention includes a packing bag 1, and a closing component 2.

The packing bag 1 is made of plastic materials, and used to pack liquid or cream-like contents such as drinks, cosmetics and detergents. The closing component 2 is joined on the packing bag 1 by means of carrying out a hot-press joining process.

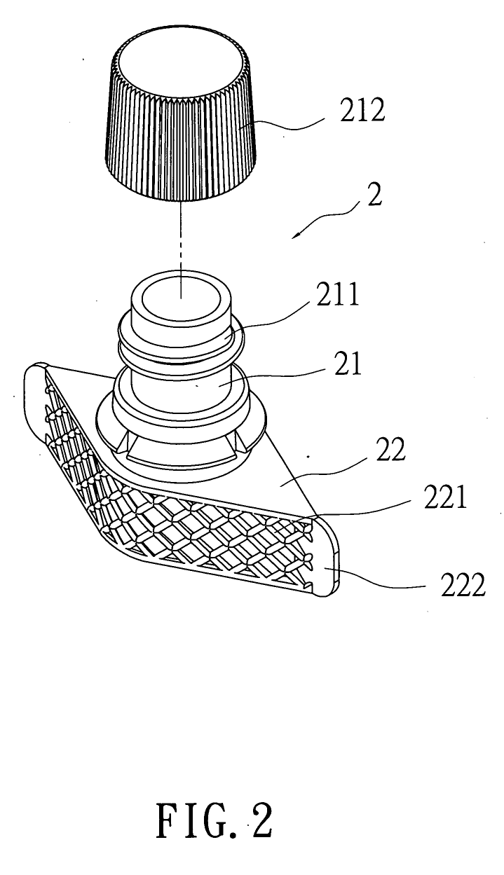

The closing component 2 has an opening end 21, and a joining end 22. Referring to FIG. 2 as well, the opening end 21 has threads 211 on an outer circumferential side thereof. The closing component 2 is further equipped with a cap 212, which can be threadedly joined on the threads 211 of the opening end 21 so as to close the closing component 2. The joining end 22 is substantially rhombic, and has a mesh-like joining piece 221 extending in a substantially upright position from each of front and rear sides thereof. The joining end 22 further has a plate-shaped piece 222 extending sideways from each of left and right vertex angles thereof.

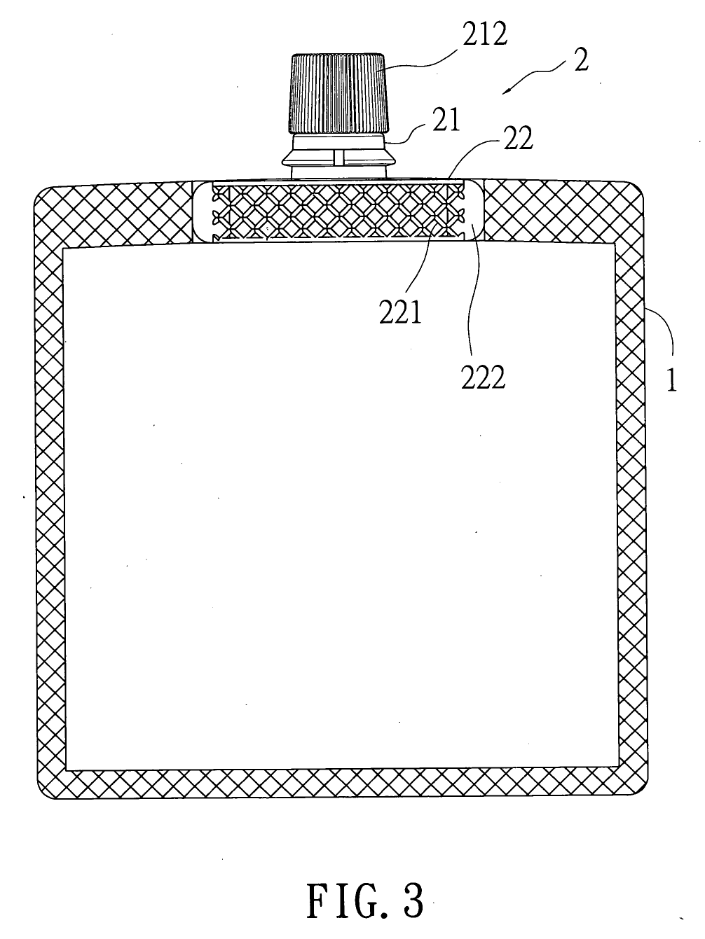

In assembly, referring to FIG. 1 to FIG. 3, first the closing component 2 is positioned on the packing bag 1 with the joining end 22 being held within an opening of the packing bag. Next, hot-press process is carried out to make the joining end 22 of the closing component 2 joined on an inner side of the packing bag 1; because the mesh-like pieces 221 and the plate-shaped pieces 222 of the joining end 22 can be firmly and watertightly joined on the inner side of the packing bag 1 more easily with the hot-press joining process, the rate of defective products will decrease in mass production, and the liquid/cream content of the packing bag 1 can't leak out through the joint between the packing bag 1 and the closing component 2.

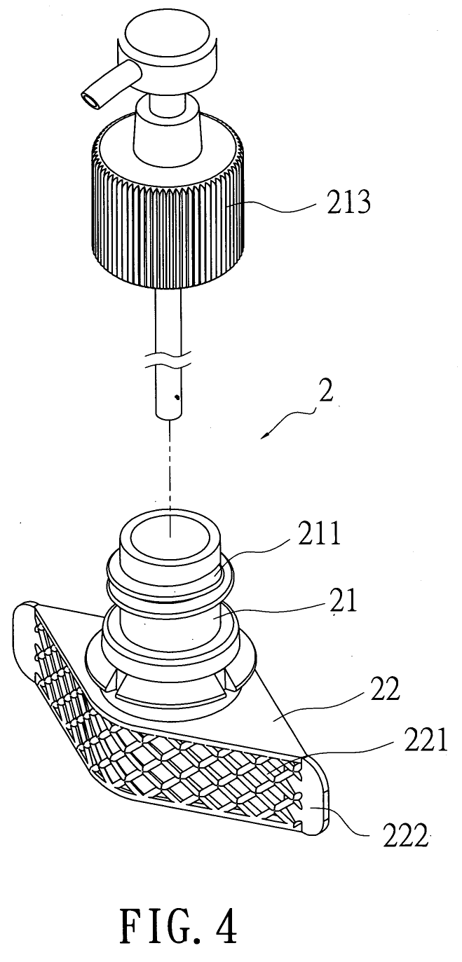

The closing component 2 of the present invention comes in various forms. In other words, the closing component 2 can be used with other closing devices besides a cap having inner threads. Shown in FIG. 4 is the second preferred embodiment 3 of a closing component of a packing container of the present invention, which has a depressible injection head 213 joined on the opening end 21 thereof.

From the above description, it can be seen that the packing container of the present invention has the following advantages over the prior art:

1. The closing component of the present packing container has mesh-like joining pieces and plate-shaped pieces, which protrude from the joining end of the closing component, and can be firmly joined on the inner side of the packing bag more easily in a hot-press joining process. Therefore, the rate of defective products with poor connection between closing components and packing bags will decrease in manufacturing.

2. Owing to the mesh-like joining pieces and the plate-shaped pieces, the joining end of the closing component will be firmly and watertightly joined on the inner side of the packing bag, and liquid content of the packing bag can't leak out through the joint between the packing bag and the closing component.

What is claimed is:

1. A packing container structure, comprising
a packing bag; and
a closing component on the packing bag; the closing component having an opening end, and a joining end; the joining end of the closing component having a plurality of mesh-like joining pieces; the closing component being firmly joined on the packing bag at the mesh-like joining pieces.

2. The packing container structure as claimed in claim 1, wherein the opening end of the closing component has threads thereon; the closing component having a cap to be threadedly joined on the threads of the opening end thereof.

3. The packing container structure as claimed in claim 1, wherein the opening end of the closing component has threads thereon; the closing component having a depressible ejection head threadedly joined on the threads of the opening end thereof.

4. The packing container structure as claimed in claim 1, wherein the joining end of the closing component has plate-shaped pieces extending sideways from vertex angles thereof.
